(19) United States
(12) Patent Application Publication
(10) Pub. No.: US 2011/0254510 A1
(43) Pub. Date: Oct. 20, 2011

(54) INTERMITTENTLY OUTPUTTED POWER SUPPLY SYSTEM

(75) Inventors: Chih-Tarng CHUANG, Taipei City (TW); Shao-Tsu Kung, Taipei City (TW)

(73) Assignee: Compal Electronics, INC., Taipei City (TW)

(21) Appl. No.: 13/088,563

(22) Filed: Apr. 18, 2011

Related U.S. Application Data
(60) Provisional application No. 61/325,822, filed on Apr. 20, 2010.

(51) Int. Cl. H02J 7/00

(52) U.S. Cl. 320/129

(57) ABSTRACT

An intermittently outputted power supply system is disclosed. The system comprises: a power input unit, a charging control circuit unit, an energy-storing unit, a discharging control circuit unit, and a power output unit. The charging control circuit unit receives a first power input through the power input unit, and charges the energy-storing unit continuously. Thus, the capacity of the energy-storing unit increases. The discharging control circuit unit converts the energy stored in the energy-storing unit into a second power and transmitted to the power output unit in such a manner of discharging intermittently, to charge the electric device being connect with the power output unit.

### CROSS REFERENCE TO RELATED APPLICATION

This application claims the benefit of filing date of U.S. Provisional Application Ser. No. 61/1325,822, entitled “Pulse output method to let smaller output power source” filed on Apr. 20, 2010 under 35 USC §119(e)(1).

### BACKGROUND OF THE INVENTION

1. Field of the Invention

The present invention relates to an intermittently outputted power supply system and, more particularly, to an intermittently outputted power supply system capable of converting an input power source with small power into an output power source with high power, which is outputted intermittently.

2. Description of Related Art

In the 3C market, miscellaneous kinds of consumer electronic devices are provided for the 3C consumers to choose with, along with the progressing of technology, such as a laptop computer, a mobile phone, and a portable audio player. Further, these consumer electronic devices contain more and more functions, in order to meet the increasing demands of the 3C consumers. However, every kind of the consumer electronic devices must be supplied with a power source. Thus, the efficiency of the battery applied in these consumer electronic products is always concern by the 3C consumers. For example, the information related to increase the efficiency of the battery, to extend the lifetime of the battery, and to raise the charging efficiency of the battery, etc.

FIG. 1 is a block diagram of a conventional power supply system. The conventional portable power supply system is connected with an electronic product having a USB connector, through a USB input socket 11. The conventional portable power supply system then receives a power source with small power from the electronic product. A charging control loop 12 receives the power source with small power and charges the secondary battery 13. Wherein the secondary battery 13 can be a nickel-metal hydride battery, a lithium battery, or other kinds of rechargeable battery. After the secondary battery has been charged, when there is a need to provide power, the conventional portable power supply system converts the power source stored in the secondary battery 13 previously, into a power source with high power by the DC-to-DC voltage-raising control loop 14. Then, the power source with high power is transmitted to an electronic product having a USB connector, which is connected to a USB output socket 15 of the conventional portable power supply system.

With the above description, it is easy to find that the power providing ability of the conventional portable power supply system is limited with the power value of the secondary battery 13, and the conventional portable power supply system is unable to output a power source with higher power to the electronic product continuously. Moreover, since the power source with higher power is provided by continuously converting the power value stored in the secondary battery 13, the stability of the outputted power source thereof is worse and easily effected by the remaining power value of the secondary battery 13. For example, once only an extremely low power value is remained in the secondary battery, the voltage of the outputted power source with higher power will drift away from a target voltage, which will deteriorate the operating stability of the electronic product connected with the conventional portable power supply system.

### SUMMARY OF THE INVENTION

The object of the present invention is to provide an intermittently outputted power supply system capable of converting a first power into a second power being outputted intermittently, wherein the voltage of the second power is greater than the voltage of the first power.

To achieve the object, the intermittently outputted power supply system of the present invention comprises a power source input unit for inputting a first power; a charging control circuit unit coupled with the power source input unit, wherein the charging control circuit unit includes a first converting circuit; an energy-stored unit coupled with the charging control circuit unit, for being charged by the charging control circuit unit, wherein an energy provided by the first power is stored in the energy-stored unit, by the charging control circuit unit; a discharging control circuit unit coupled with the energy-stored unit, wherein the discharging control circuit unit includes a pulse discharging control circuit unit and a second converting circuit, the energy stored in the energy-stored unit is converted into a second power by the discharging control circuit unit, and the second power is outputted intermittently, wherein the voltage of the second power is greater than the voltage of the first power; and a power source output unit coupled with the discharging control circuit unit, wherein the power source output unit charges an electronic device with the intermittently outputted second power .

Wherein, the charging control circuit unit charges the energy-stored unit continuously, for increasing the power value of the energy-stored unit. In addition, when the power value of the energy-stored unit is equal to or greater than a discharging threshold or the charging period is achieving a predetermined value, the discharging control circuit unit controls the energy-stored unit to discharge at a discharging rate rapidly, making the power source output unit to output the second power. Then, once the power value of the energy-stored unit is equal to or smaller than a charging threshold, the charging control circuit unit starts to charge the energy-stored unit, for increasing the power value of the energy-stored unit once again, until the energy-stored unit to be discharged again rapidly.

As a result, since the power source input unit of the intermittently outputted power supply system of the present invention receives a first power (not shown in the figure), and the charging control circuit unit charges the energy-storing unit continuously. Besides, the a charging control circuit unit controls the output frequency of the second power output from the power source output unit, depending on the pulse discharging control circuit unit embedded therein. Therefore, the intermittently outputted power supply system of the present invention can output an output power intermittently, wherein the power of the output power is greater than the power of the input power received by the intermittently outputted power supply system of the present invention. In different designs of the products, the voltage of the output power can be greater than that of the input power.

Moreover, the intermittently outputted power supply system of the present invention can further comprise a control element, which is used to detect the power value of the energy-stored unit. The formation of the control element is not limited; it can be any kind of suitable element, such as a power value detecting circuit. In addition, any element capable of detecting the power value can be applied in the intermittently outputted power supply system of the present invention. Besides, the aforementioned first converting circuit and the second converting circuit is a DC-to-DC converter, for converting power in the intermittently outputted power supply system of the present invention.

It should be notice that, in the intermittently outputted power supply system of the present invention; the power source input unit can be a USB port or an inserting hole corresponding to the adapter of the mobile phone. Besides, the power source output unit can be a USB port or an adapter plug corresponding to an inserting hole of a laptop computer. In addition, the power source input unit is preferably a USB port, while the power source output unit is preferably an adapter plug corresponding to an inserting hole of a laptop computer. Moreover, the energy-stored unit can be a capacitor or a secondary battery having a high charging rate and/or discharging rate. On the hand, the formation of the DC-DC converter included by the charging control circuit unit and the discharging control circuit unit is not limited; any circuit module capable of converting voltage can be applied in the charging control circuit unit and the discharging control circuit unit of the intermittently outputted power supply system of the present invention.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a conventional power supply system.

FIG. 2 is a block diagram of the intermittently outputted power supply system according to first embodiment of the present invention.

FIG. 3 displays the composition of the charging control circuit unit of the intermittently outputted power supply system according to first embodiment of the present invention.

FIG. 4 displays the composition of the discharging control circuit unit of the intermittently outputted power supply system according to first embodiment of the present invention.

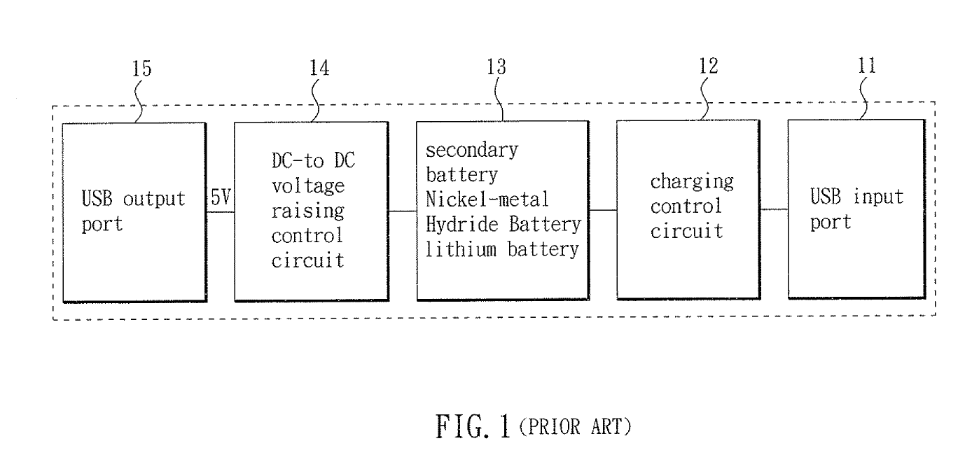

### DETAILED DESCRIPTION OF THE PREFERRED EMBODIMENT

The intermittently outputted power supply system of the present invention is used to convert a first power into a second power, for example, converting a first power used for charging a mobile phone into a second power for the usage of an electronic device, such as charging the embedded battery of a laptop computer. In different designs of the products, the power of the second power can be greater than that of the first power, or the voltage of the second power can be larger than that of the first power.

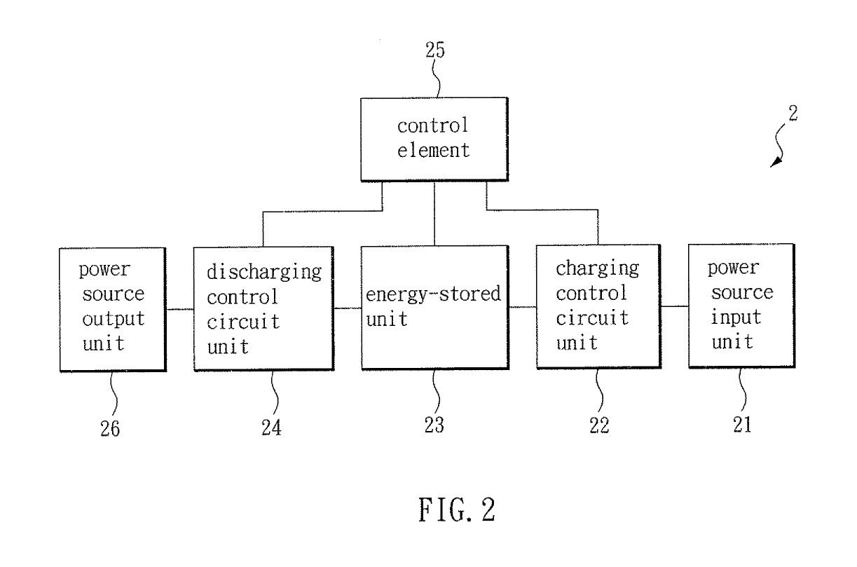

With reference to FIG. 2, which is a block diagram of the intermittently outputted power supply system according to first embodiment of the present invention, the intermittently outputted power supply system 2 comprises a power source input unit 21, a charging control circuit unit 22, an energy-stored unit 23, a discharging control circuit unit 24, and a power source output unit 26. Wherein, the power source input unit 21 is used for receiving (in other words, inputting) a first power (not shown in the figure). The charging control circuit unit 22 is coupled with the power source input unit 21, for storing the energy provided by the first power in the energy-stored unit 23. The energy-stored unit 23 has a power value and a maximum power value. In the present embodiment, the power source input unit 21 can be a USB port or an ordinary power connector. The energy-stored unit can be a secondary battery or a capacitor. However, the example provided above is only used for exemplifying use, not for limiting the scope of the present invention.

The intermittently outputted power supply system of the present invention can further comprise a control element 25, which is coupled with the charging control circuit unit 22, the energy-stored unit 23, and the discharging control circuit unit 24. The control element 25 is used to detect the power value of the energy-stored unit 23. The formation of the control element 25 is not limited; it can be any kind of suitable element, such as a power value detecting circuit. As a result, any element or circuit capable of detecting the power value can be applied in the intermittently outputted power supply system of the present invention.

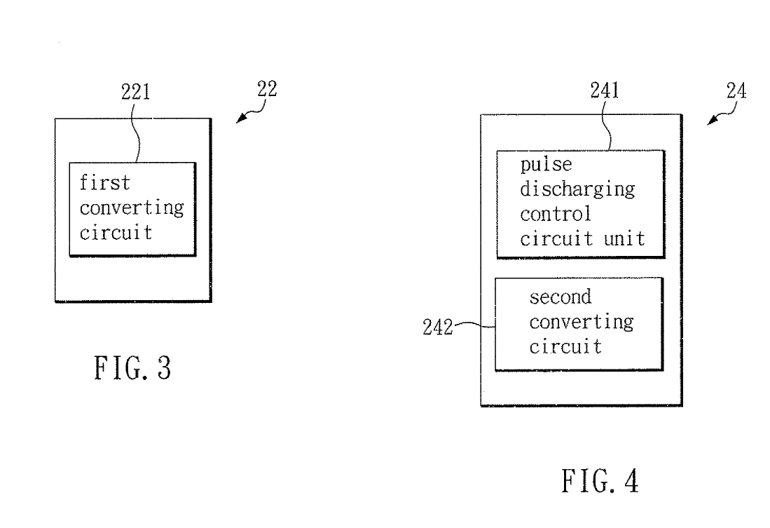

In addition, as shown in FIG. 3, the charging control circuit unit 22 includes a first converting circuit 221, for converting the aforementioned parameters of the first power into energy storable parameters, wherein the energy storable parameters could be voltage values or current values, but the scope of the energy storable parameters is not thus limited. Wherein, the first converting circuit 221 is a DC-to-DC converter, for converting the power in the intermittently outputted power supply system of the present invention. In the present embodiment, the aforementioned first power is a power outputted from an adapter of the small-sized mobile electronic device, wherein the voltage of the outputted power is 5 volt, and the current of the power of the outputted power is a DC current of 0.5 ampere. The small-sized mobile electronic device can be a mobile phone, a personal digital assistant (PDA), and a digital camera, etc.

On the other hand, please refer to FIG. 2 and FIG. 4, the discharging control circuit unit 24 is coupled with the energy-stored unit 23. The discharging control circuit unit 24 includes a pulse discharging control circuit unit 241 and a second converting circuit 242, for converting the energy stored in the energy-stored unit 23 into a second power (not shown in the figure). Then, the second power is outputted from the power source output unit 26 intermittently. Wherein, the second converting circuit 242 is a DC-to-DC converter for converting the power in the intermittently outputted power supply system of the present invention. The second power is used as the power of an electronic device needs a bigger power, such as the power of a laptop computer. As a result, the parameters of the second power must meet the charging parameters of the big-sized electronic device. In different designs of the products, the intermittently outputted power supply system of the present invention can be integrated with the electronic device, enabling the electronic device to be charged by the first power.

When the intermittently outputted power supply system of the present invention is operating, the charging control circuit unit 22 charges the energy-stored unit 23 continuously with the first power from the power source input unit 21, for increasing the power value of the energy-stored unit 23. In the present embodiment, the energy-stored unit 23 has a high charging rate, which is between 5 C and 20 C.

When the power value of the energy-stored unit 23 is equal to or greater than a discharging threshold T_{discharge} or the charging period is equal to or longer than a predetermined period, the discharging control circuit unit 24 controls the energy-stored unit 23 to discharge at a discharging rate rapidly. In the present embodiment, the aforementioned discharging threshold is between 95% and 99.5% of the maximum power value of the energy-stored unit 23, while the discharging rate is between 5 C and 20 C.

Thus, the power source output unit 26 of the intermittently outputted power supply system of the present invention outputs the second power intermittently. The second power can be a DC power having the voltage between 15 and 25 volt and the current between 3 and 5 ampere. In addition, the power source output unit 26 is an adapter plug corresponding to an inserting hole of a laptop computer, for providing the second power to a laptop computer, such as charging the embedded battery of the laptop computer. In different designs of the products, the power source output unit 26 can be connected with the power inserting hole or USB port, but the scope of the present invention is not thus limited.

After the energy-stored unit 23 being discharged, the power value thereof decreases rapidly. Once the power value of the energy-stored unit 23 is equal to or smaller than a charging threshold T_{charge}, the charging control circuit unit 22 starts to charge the energy-stored unit 23, for increasing the power value of the energy-stored unit 23 once again, until the energy-stored unit 23 to be discharged again rapidly. In the present embodiment, the aforementioned charging threshold is between 2% and 0.5% of the maximum power value of the energy-stored unit 23.

The discharging control circuit unit 24 further comprises a switch (not shown in the figure). The switch is mainly used for preventing the flowing back of the electric energy, which is from the electronic device toward the energy-stored unit 23, as the voltage of the energy-stored unit 23 being smaller than the voltage of the battery of the electronic device after the energy-stored unit 23 being discharged. Therefore, the switch of the discharging control circuit unit 24 can be a MOS switch, for preventing the electric energy being transmitted to the energy-stored unit.

As a result, since the power source input unit of the intermittently outputted power supply system according to first embodiment of the present invention receives a first power, and the charging control circuit unit charges the energy-storing unit continuously. The control element then controls the output frequency of the second power output from the power source output unit, depending on the capacity of the battery of the energy-storing unit and the pulse discharging control circuit unit. Thus, the intermittently outputted power supply system according to first embodiment of the present invention can output an output power having a steady output voltage intermittently, wherein the power of the output power is greater than the voltage of the input power. As a result, the intermittently outputted power supply system of the present invention can charge a larger-sized electronic device by a first power outputted from an adapter of a smaller-sized electronic device, enabling the user to charge the larger-sized electronic device without the need to bring more adapters with him/her.

Although the present invention has been explained in relation to its preferred embodiment, it is to be understood that many other possible modifications and variations can be made without departing from the spirit and scope of the invention as hereinafter claimed.

What is claimed is:

1. An intermittently outputted power supply system comprising:
a power source input unit for inputting a first power;
a charging control circuit unit coupled with the power source input unit, wherein the charging control circuit unit includes a first converting circuit;
an energy-stored unit coupled with the charging control circuit unit, for being charged by the charging control circuit unit, wherein an energy provided by the first power is stored in the energy-stored unit, by the charging control circuit unit;
a discharging control circuit unit coupled with the energy-stored unit, wherein the discharging control circuit unit includes a pulse discharging control circuit unit and a second converting circuit, the energy stored in the energy-stored unit is converted into a second power by the discharging control circuit unit, and the second power is outputted intermittently, wherein the voltage of the second power is greater than the voltage of the first power; and
a power source output unit coupled with the discharging control circuit unit, wherein the power source output unit charges an electronic device with the intermittently outputted second power.

2. The intermittently outputted power supply system as claimed in claim 1, wherein the power source input unit is a USB port, and the power source output unit is an adapter plug corresponding to an inserting hole of a laptop computer.

3. The intermittently outputted power supply system as claimed in claim 1, wherein the discharging control circuit unit further comprises a switch for preventing the flowing back of the electric energy, from the electronic device toward the energy-stored unit.

4. The intermittently outputted power supply system as claimed in claim 1, wherein the first converting circuit and the second converting circuit are a DC-to-DC converter, respectively.

5. The intermittently outputted power supply system as claimed in claim 1, wherein the energy-stored unit is a secondary battery or a capacitor.

6. The intermittently outputted power supply system as claimed in claim 1, wherein the energy-stored unit has a maximum power value, and a discharging threshold is between 95% and 99.5% of the maximum power value.

7. The intermittently outputted power supply system as claimed in claim 6, wherein a charging threshold is between 2% and 0.5% of the maximum power value.

8. The intermittently outputted power supply system as claimed in claim 1, wherein the pulse discharging control circuit unit controls the discharging of the energy-stored unit at a discharging rate rapidly, and the discharging rate is between 5 C and 20 C.

9. The intermittently outputted power supply system as claimed in claim 1, wherein the intermittently outputted power supply system is installed inside the electronic device.

10. The intermittently outputted power supply system as claimed in claim 1, further comprising a control element for detecting the power value of the energy-stored unit.
